(19) United States
(12) Patent Application Publication
(10) Pub. No.: US 2008/0241487 A1
(43) Pub. Date: Oct. 2, 2008

(54) System and Method for Rendering an Image Onto an Object

(76) Inventors: Mary Tomes, Oxford (GB); Kevin Tomes, Oxford (GB)

Correspondence Address: DALY, CROWLEY, MOFFORD & DURKEE, LLP, SUITE 301A, 354A TURNPIKE STREET, CANTON, MA, 02021-2714, US

(21) Appl. No.: 12/063,896

(22) PCT Filed: Jul. 31, 2006
(86) PCT No.: PCT/GB06/02859

§ 371 Date: Feb. 15, 2008

(30) Foreign Application Priority Data
Aug. 15, 2005 (GB) 0516775.6

(51) Int. Cl. B44C 1/16; G09F 3/04; B32B 7/12

(52) U.S. Cl. 428/195.1; 427/147; 428/40.1; 156/230; 156/240

(57) ABSTRACT

A system and method for rendering an image onto an object is described which can provide an improved method for transferring images onto the surface of a three dimensional object. The image is created onto paper-based or vinyl-type material which is then applied to, or forms the surface of an object such as a box, cupboard, storage chest, drinks container, nesting box and casket, etc., thereby enhancing the appearance and structural integrity of the object. In particular, the method is highly suited to objects having curved or angular components as the image-carrying medium may stretch to match the shape of the object. The image rendering method makes possible the use of low cost construction materials for creating the object and in several embodiments includes a new type of folding joint to enable the rendering of unimpaired images upon complex angled and curved shaped surfaces such that rendered objects of diverse and desirable shapes can be formed.

### BACKGROUND OF THE INVENTION

The invention relates to a system and method for rendering an image onto an object. More particularly, it relates to a system and method for rendering an image onto a surface material, which can cover or form a variety of three-dimensional objects. In particular, the invention teaches a method for creating consumer objects, which are enhanced by images to make them more appealing as well as improving the structural integrity of the said objects.

The invention is particularly addressed towards the creation of enhanced consumer goods such as boxes, cupboards, storage chests, drinks containers and caskets, but it is not limited to these applications. The method teaches both an image rendering process as well as a set of solutions to enable the creation of image-enhanced objects made of low cost structural material.

In several applications, the novel and inventive image rendering method makes use of vinyl-like film and paper media to cover prefabricated consumer products. This enables an efficient technique for associating exciting imagery or advertising text with the said objects. In this way, the surface of the object is both protected by the vinyl-like film coating as well as made more attractive or used to promote a company's name.

Generally, there are problems associated with enhancing the appearance of pre-manufactured consumer goods since it is complicated and expensive to render such objects easily with high quality images. Moreover, the objects themselves may be low cost to produce and standard techniques of rendering images are too expensive to justify for such articles.

It is generally known how to print images directly onto objects or how to stick pre-printed labels onto objects to enhance their appearance. Such methods are suitable for most consumer goods up to a certain size and of a certain shape. When objects exceed a certain size, or are of complicated shapes, then it becomes extremely difficult to use existing printing methods and image rendering equipment to obtain a desired result. In some instances, it is desirable to cover an object completely with a single rendered image, such as in the case of a door or cupboard or casket.

An additional problem with rendering images on larger objects is the need to create a continuous unbroken surface, which presents challenges for existing equipment. In particular, cupboards, doors and caskets often have dimensions larger than the equipment capable of rendering an image.

From the perspective of material construction, there are opportunities to enhance the appearance and the structural integrity of an object using an image rendering technique, which makes use of strong vinyl-like sheeting as the image-carrying medium. This approach makes possible the covering of a wide variety of objects including vehicle surfaces, caravan roofs, table tops, partition walls such that the surface structure and or paintwork is protected as well as strengthened. In particular instances, the same technique may be used to cover consumer items such as mobile phones and thereby provide a way to personalise them with exciting images while protecting their surface.

Today, image rendering techniques for objects of complex shapes are limited because adhering a printed cover onto a three dimensional shape often loses the sharp relief or curvature of angled sides, and thereby degrades the appearance, or air bubbles or folds are created in the image medium when it is applied. Moreover, a large category of objects is deemed to be unsuitable for covering with an image-carrying medium.

The industry would certainly benefit from a system and method, which would enable the application of images to complex-shaped articles.

Lightweight yet strong materials such as reinforced cardboard may be used effectively to create low cost practical household goods such as cupboards and boxes. Such materials have high compression resistance but due to their appearance and right-angled sides, boxes made from these materials are generally only used for storage. Insufficient research has been performed to determine how to curve or angle this type of material while providing enhanced structural integrity. A technique which both enables the creation of angular-formed structures having joints and curves comprising high-compression resistance and combined with an enhanced image rendering technique would make possible the creation of attractive, yet low cost, three dimensional consumer goods of a wide variety of shapes and forms.

At exhibition halls and promotional events, there are opportunities to advertise products and services by printing company information on banners, posters and paper cartons. There is clearly a market opportunity to enhance the delivery of company promotional material by rendering a wide variety of objects with high quality images using an enhanced technique. Such an approach would make possible the provision of semi-permanent images on seat backs, seat bases, tabletops, litterbins, and drinking-containers which would not only deliver the desired promotional material, but also protect the surfaces of the said tables and chairs etc.

At sports events, such as at Olympic venues, additional advertising space could be sold to include tabletops and seat backs. Furthermore, the semi-permanent nature of the image rendering technique would enable ease of removal and updating of messages as desired.

Wherever, there are household products or corporate products, which would benefit from imaging or association with a company, the enhanced image rendering technique according to the current invention can be applied effectively and economically to achieve an improved result compared with prior art techniques.

Today, consumers seek low cost products such as storage boxes and the like having desirable images upon their surfaces. Consequently, as long as the boxes have the sought structural integrity, the type of material used is not of any particular consequence. Should it be possible to create a low cost and stylish shaped container, which is lightweight and cheap to manufacture, and is rendered with a highly desirable image or theme of colours and shapes, then such products will secure strong market pull.

Furthermore, consumers seek ways to enhance the appearance of their vehicles, such as cars, motorcycles, bicycles, caravans and Recreational Vehicles, often in a personalised way. Conventional techniques usually involve stylised paintwork, which is expensive and does not afford any protection to damage from stone chippings. There are clear opportunities for image rendering techniques, which can resolve this market need in a cost effective and appropriate way.

In the field of caskets, the market is characterised by products addressing an especially sensitive area. Today, caskets are generally manufactured of hard wood or metal for burial, while the market for cremations predominantly makes use of veneered chipboard or veneered MDF. The cost of caskets is unnecessarily high due to the desire to use such materials.

To address this incineration of high cost caskets, a number of patent applications have been filed. In European Patent Application EP-A-1475065 filed by Joseph A. Hey & Son Ltd, claiming priority of May 9th 2003, a cardboard inner container is proposed which sits inside a standard veneered wooden outer casket. While this method addresses the waste of quality materials, it is not optimised towards the creation of a highly desirable product comprising attractive and personalised images on its surface.

The main problem with conventional casket designs is that it is not generally possible to construct a cardboard coffin of a desired shape while maintaining the required compressional strength of the sides. Consequently, prior to the teaching of this invention, casket designs making use of low cost lightweight materials are of a purely rectilinear form having all angles of 90 degrees.

No systems are presently known to the applicant, which address this market need in a highly effective and economic way.

Further to the limitations of existing technologies used to render images onto objects, and so far as is known, no optimised system and method for rendering images upon objects is presently available which is directed towards the specific needs of this problem area as outlined.

### OBJECTS OF THE INVENTION

Accordingly, it is an object of the present invention to provide an improved system and method for rendering an image upon an object, which can cover I or form a surface for, or form a variety of, three-dimensional objects.

It is a further object of one embodiment of the present invention to provide a system and method for rendering an image onto an object to create new and exciting consumer objects, which are enhanced by images to make them more appealing as well as improving the structural integrity of the said objects.

It is a further object of one embodiment of the present invention to provide a system and method for rendering an image onto an object to create enhanced consumer goods such as boxes, cupboards, storage chests, drinks containers and caskets and the like.

It is a further object of one embodiment of the present invention to provide a system and method for rendering an image onto an object to create consumer goods having enhanced appearance and structural integrity, which can be made of low cost structural material.

It is a further object of one embodiment of the present invention to provide a system and method for rendering an image onto an object in which the inventive image rendering method makes use of vinyl-like film and or paper media to carry the image and whereby this film and or paper media is applied to the surface of the said object.

It is a further object of one embodiment of the present invention to provide a system and method for rendering an image onto an object such that the image rendering method makes use of vinyl-like film and or paper media such that the surface of the object is both protected by the vinyl-like film coating as well as made more attractive.

It is a further object of one embodiment of the present invention to provide a system and method for rendering an image onto an object such that the image rendering method makes use of vinyl-like film and or paper media such that the image is printed in a spiral format to enable the image surface to wrap around 3 or more vertical rods, each set into a horizontal base and spaced equally apart such that the vinyl-like film or paper media overlaps partially and precisely to create both a continuous image and a continuous surface such that a container is formed of the rod and base and image surface material which is suitable to create a low cost prism-shaped or rectangular or cylindrical container or the like.

It is a further object of one embodiment of the present invention to provide a system and method for rendering an image onto an object such that the image rendering method creates a continuous unbroken surface when applied to the object in the form of a vinyl-like film or a paper medium.

It is a further object of one embodiment of the present invention to provide a system and method for rendering an image onto an object such that the image rendering method comprises stretching the vinyl-like film over the surface of the three dimensional object such as in the case of applying an image to a mobile phone or computer device, and to all objects comprising angled or curved surfaces, such as chair backs and the like.

It is a further object of one embodiment of the present invention to provide a system and method for rendering an image onto an object such that the image rendering method makes use of strong vinyl-like sheeting as the image-carrying medium to make it highly suitable for covering a wide variety of objects including vehicle surfaces, caravan roofs, table tops, partition walls such that the surface structure and or paintwork of the said objects is protected as well as strengthened by the image rendering method.

It is a further object of one embodiment of the present invention to provide a system and method for rendering an image onto an object such that the image rendering method makes use of transparent or semi-transparent or translucent film or of films of appropriate heat transfer characteristics such that it is suitable for application to glass products and or windows and or lighting systems. In this embodiment, permanent or semi-permanent images can be applied to windows such as in school classrooms, or on public transport windows such as on buses and trains. Furthermore, in the instance that this method may be applied to paper cups or flasks or containers in general, the said variety of films may possess heat transfer characteristics which provide insulation to help maintain the contents, such as drinks in the example of paper cups, at the temperature that they were dispensed into the said cups, thereby keeping cold drinks cooler, and or hot drinks warmer for a longer period.

It is a further object of one embodiment of the present invention to provide a system and method for rendering an image onto an object such that the image rendering method is efficiently and precisely applied to objects of complex shapes such as those having angled and or curved sides.

It is a further object of one embodiment of the present invention to provide a system and method for rendering an image onto an object such that improved tools and utensils can be produced comprising protective films containing images and information as required.

It is a further object of one embodiment of the present invention to provide a system and method for rendering an image onto an object such that the image rendering method is applied directly to lightweight strong materials such as reinforced cardboard to create low cost practical and stylish household goods such as cupboards and boxes enhanced by images, wherein the images are either rendered onto the material before it is folded into a desired shape to form the object or the images are rendered upon the object after construction.

It is a further object of one embodiment of the present invention to provide a system and method for rendering an image onto a surface made of lightweight strong material such as reinforced cardboard in which novel joints are introduced to enable the creation of objects having curved or angular shaped sides while maintaining the structural integrity of the said curved and or angular shaped sides and thus making the object suitable for rendering according to the method of the current invention. In this instance the rendering method is thus also possible while the material is in flat unfolded form and by way of the novel joints can thus fold to form a desired shape of container or box or chair or the like.

It is a further object of one embodiment of the present invention to provide a system and method for rendering an image onto an object made of lightweight strong material formed from folding said material in which the novel joints comprise areas where material is removed on one side of the said material according to a specific pattern to enable the material to be folded and or curved to form objects of a variety of desired shapes and forms and where the structural integrity of the curved or folded area is maintained.

It is a further object of one embodiment of the present invention to prepare a material suitable for its surface to be rendered with an image and then be folded into an object of a desired shape wherein the material is a lightweight, strong and semi-rigid material, such as reinforced cardboard comprising two sheets of cardboard separated by a rigid spacing material or the like of the type, for example made by Dufaylite of Cromwell Road, Saint Neots, Cambridgeshire UK, wherein a variety of the objects are formed from folding said material using novel joints according to the current invention. Said novel joints comprise a continuous cut made on one surface of the material and a sequence of alternating equal quadrilateral voids removed from either side of the said cut to leave a sequence of quadrilateral projections which interlock and enable the cardboard or the like to form a very strong angled fold along the line of the cut, while leaving the other surface of the material completely intact at the location of the joint, wherein the angle of the fold is variable and controllable and determined by the width of the quadrilateral voids at right angles to the continuous cut.

It is a further object of one embodiment of the present invention to describe a method for preparing a material suitable for its surface to be rendered with an image and then be folded into an object of a desired shape comprising angled folds wherein the said method involves making one or more continuous cuts on one surface of the material and then removing quadrilateral sections of material either side of the said one or more cuts to leave quadrilateral voids which can interlock and enable the material to fold or curve at that location.

It is a further object of one embodiment of the present invention to prepare a material suitable for its surface being rendered with an image and then being folded into an object of a desired shape comprising angled folds using novel interlocking joints formed on one surface of the material only wherein two or more continuous cuts comprising interlocking quadrilateral sections are formed in parallel and in appropriate proximity such that a series of step folds and or a curve can be made in the material at the location of the said folds in such a way that the angle of curvature is completely controllable by varying the width of the quadrilateral sections at right angles to each continuous cut and the proximity of each continuous cut to another such that when the quadrilateral sections interlock along each continuous cut, the structural integrity of the material at that location is maintained.

It is a further object of one embodiment of the present invention to prepare a material suitable for its surface being rendered with an image and then being folded into an object of a desired shape comprising angled folds using novel interlocking joints which may be formed on both sides of the material according to the direction in which the material of which an object is to be made is to be curved or folded so that the material can be folded in a plurality of different directions at different places in the material.

It is a further object of one embodiment of the present invention to manufacture a variety of desirable consumer products rendered with images which are constructed of rigid lightweight material comprising diverse angled and curved shapes, which make use of angled folds comprising one or more continuous cuts on one surface of the material and where quadrilateral sections of material are removed either side of the said one or more cuts to leave quadrilateral voids which can interlock and enable the material to fold or curve at that location to create the desired said products. In particular, the desired said products may comprise: coffins, ashes caskets, pet caskets, chairs and chair seats, wardrobes, drawer fronts, partition walls, exhibition stands, toy boxes, storage boxes, bedroom headboards, flower pots, waste bins, dog excrement bins, exhibition stands, interlocking storage boxes, comprising part or complete images which may stack together wherein part images combine to form a complete image, dog kennels, nesting boxes, and other such consumer articles.

It is a further object of one embodiment of the present invention to provide a system and method for rendering an image onto an object made of lightweight strong material wherein the image is printed directly onto the surface of the lightweight strong material before being folded into the new and desirable shapes making use of the novel joints and folds.

It is a further object of one embodiment of the present invention to provide a system and method for forming objects to be rendered with images wherein the object is made of lightweight strong material, which comprises a composite sheet of a plurality of semi-rigid sheets containing a rigid spacing material between the said sheets such that alternative materials may be substituted for the outer sheets and spacing material other than cardboard derivatives such as, for example, some forms of plastic-like and carbon-fibre sheeting where appropriate depending upon the physical characteristics required of the object. In the embodiments of the invention which use multiple sheets separated by spacing material, the method of making the novel joint by making a cut on one side of the composite material and removing quadrilateral sections of material on either side of the cut would involve removing quadrilateral sections of material up to but not including the final sheet which forms the outer surface, thereby maintaining the integrity of the surface.

It is a further object of one embodiment of the present invention to provide a system and method for forming objects to be rendered with images wherein the object is made of lightweight strong material, which comprises a composite sheet of a plurality of semi-rigid sheets containing a rigid spacing material between the said sheets wherein the novel joint is a alternatively formed by removing a continuous and symmetrical serpentine strip of material from one surface of the material, which includes removing some or all of the spacing material of a depth up to but not including the opposite surface so that a fold can be made at that location wherein the continuous serpentine cut leaves alternate projections which can interlock with each other and where the angle of the fold is determined by the width of the serpentine cut corresponding to the material removed.

It is a further object of one embodiment of the present invention to provide a system and method for rendering an image onto an object such that the image rendering method is highly suitable for the creation of semi-permanent promotional material to be applied to seat backs, seat bases, tabletops, litterbins, partition walls, exhibition stands, and drinking containers etc., which would not only deliver the desired promotional material, but also protect the surfaces of the said tables and chairs etc.

It is a further object of one embodiment of the present invention to provide a system and method for rendering an image onto an object such that the image rendering method is suited to outside stadiums, such as at Olympic venues, wherein it can provide the method for creating semi-permanent advertising space such as for tabletops and seat backs. Furthermore, the semi-permanent nature of the image rendering technique would enable ease of removal and updating of advertising messages as desired.

It is a further object of one embodiment of the present invention to provide a system and method for rendering an image onto an object such that the image rendering method is suitable for the creation of low cost and stylish shaped containers, which are lightweight and cheap to manufacture, and rendered with highly desirable images or themes of colours and shapes.

It is a further object of one embodiment of the present invention to provide a system and method for rendering an image onto an object such that the image rendering method is suitable for enhancing the appearance and resistance to surface damage of vehicles, such as cars, motorcycles, bicycles, caravans and Recreational Vehicles, often in a personalised way.

It is a further object of one embodiment of the present invention to provide a system and method for rendering an image onto an object such that the image rendering method is suitable for caskets such that cheaper, lightweight and structurally strong caskets can be built and rendered completely with a surface image such that the material used to make the casket cannot be seen which makes possible the creation of a highly attractive casket at low cost.

It is a further object of one embodiment of the present invention to provide a system and method for rendering an image onto an object surface, which makes use of printing an image upon adhesive backed vinyl, which is laminated and applied to the surface of the said object such that the vinyl can be stretched to conform to almost any shape and thereby enhance the appearance of, and protect the surface of the said object.

It is a further object of one embodiment of the present invention to provide a system and method for rendering an image onto an object surface, which makes use of printing an image upon adhesive backed paper, which is laminated with, for example, a polyester based laminate and applied to the surface of an object.

It is a further object of one embodiment of the present invention to provide a system and method for rendering an image onto a surface, which makes use of printing an image upon paper and then subsequently applying an adhesive or adhesive sheet to the reverse side of the paper and laminating the front of the paper with, for example, a polyester laminate to form a paper composite sheet and applying this paper composite to the surface of one or more of a variety of objects.

It is a further object of one embodiment of the present invention to provide a system and method for rendering an image onto an object, which makes use of flatbed printing such that flat pack objects can be rendered with images directly wherein such method makes possible the rendering of different materials such as fabric, wood, stone and plastic as well as paper, cardboard and vinyl-like sheets. Different inks comprising weatherproof, and or waterproof, and or heatproof and or permanent inks may be used such that the images are resistant to chemical, heat, water or weather damage.

It is a further object of different embodiments of the present invention to provide a system and method for rendering an image onto an object, which makes possible the creation of a wide variety of objects including coffins, ashes caskets, pet caskets, table tops, chair seats, mobile phones, power tools, computer cases, doors, wardrobes, drawer fronts, windows, walls, partition walls, exhibition stands, toy boxes, storage boxes, caravans, motor homes, horse-boxes, freight containers, surf boards, bedroom headboards, and nesting boxes and the like.

It is a further object of different embodiments of the present invention to provide a system and method for rendering an image onto an object using a flatbed printing method which makes possible the creation of a wide variety of objects of different materials including coffins, ashes caskets, pet caskets, tombstones, curtains and blinds, fence panels, toy boxes, room dividers/partitions, flower pots, waste bins, dog excrement bins, exhibition stands, pots and vases for special events such as weddings, bedroom storage boxes comprising part or complete images which may stack together wherein part images combine to form a complete image, wardrobes, dressing tables, doors, bath panels, serving trays, handbags, clothing, dog kennels, nesting boxes and other such consumer articles.

Other objects and advantages of this invention will become apparent from the description to follow when read in conjunction with the accompanying drawings.

### BRIEF SUMMARY OF THE INVENTION

Certain of the foregoing and related objects are readily-attained according to the present invention by the provision of a novel system and method for rendering an image upon a surface, which serves to address the diverse requirements for creating different structures and consumer devices enhanced in appearance by a new and inventive rendering method which may also make use of lightweight rigid and semi-rigid materials which can be folded or curved according to a novel and inventive joint and objects formed of the same.

The system and method for rendering an image upon the surface of an object in the preferred embodiment makes possible the creation of a variety of new objects formed of low cost constructional materials comprising diverse curved and angled shapes while maintaining the structural integrity of the said objects in the region of the curves and angled joints. In particular the novel joints make possible a whole new range of stylish shapes and forms of consumer products which are not only enhanced in structural integrity and by the imagery which they bear using the method of the invention but are also cheaper.

The invention is particularly directed to forming objects made of lightweight but strong materials such as reinforced cardboard or plastic composite boards comprising two outer sheets separated by a rigid spacing material, which is known to be generally difficult to curve or shape in non rectilinear forms. According to alternative embodiments, the current invention provides for a system and method to create stylish objects of enhanced appearance and diverse curved and angular forms made possible by combining the rendering technique with a number of novel folding and jointing techniques.

The complete rendering of the outer surface of the material with images when created from a flat pack format or alternatively when the said rendering is applied to the constructed object as a vinyl-like or paper coating totally hides the nature of the type of constructional material used. Consequently stylish shaped objects made of low cost materials can be constructed offering cheaper yet fashionable alternatives for many consumer products currently made of unnecessarily expensive materials.

The system and method according to the invention has advantageous application to the construction of coffins and pet caskets and dog kennels and nesting boxes which can now be constructed of low cost materials such as reinforced cardboard yet be covered completely with beautiful images.

Other objects and features of the present invention will become apparent from the following detailed description considered in connection with the accompanying drawings, which disclose one key embodiment of the invention. It is to be understood, however, that the drawings are designed for the purpose of illustration only and that the particular descriptions of the casket and nesting box are given by way of example only and do not limit the scope of the invention.

### BRIEF DESCRIPTION OF THE DRAWINGS

FIG. 1 illustrates a schematic of a casket design, which can be rendered with an image according to the system, and method of the current invention, which makes use of novel joints to maintain the necessary structural integrity as well as forming the desired shape.

FIG. 2 illustrates an alternative schematic of a casket design.

FIG. 3 illustrates a schematic for a nesting box.

FIGS. 4A, 48, and 4C illustrate schematic showing details of the types of joints used to angle and curve the material into consumer goods of stylish shapes and forms.

FIG. 5 illustrates a schematic of an alternative implementation of the novel joint according to the current invention.

FIG. 6 illustrates a design of a prism-like container making use of a spiral rendered image upon a vinyl-like or paper media wrapped around rods set into a base.

### DESCRIPTION OF A PREFERRED EMBODIMENT

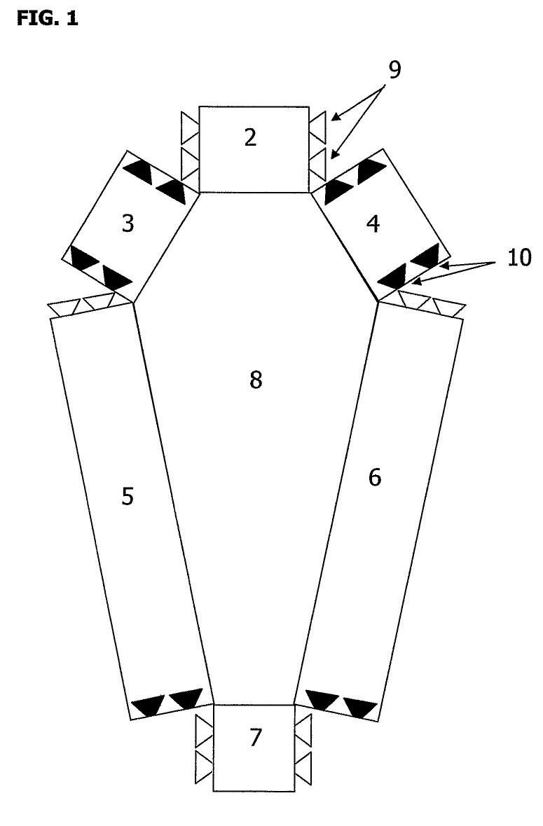

Referring now in detail to the drawings and in particular FIG.1 thereof, therein illustrated is an example of a container design, which greatly benefits from the system and method of the current invention. In this instance, the container comprises a coffin design.

The following description makes full reference to the detailed features as outlined in the objects of the invention.

The design is suitable that it can be made from a wide variety of reinforced cardboard materials or other such materials comprising two semi-rigid sheets separated by a rigid spacing material.

As stated earlier, the main problem with conventional casket designs is that it is not generally possible to construct a cardboard coffin of a desired shape while maintaining the required compressional strength of the sides at the locations of non-rectilinear joints. The design shown in FIG. 1 directly addresses this requirement.

In addition, there are often instances when it is preferred to maintain the integrity of the outer surface of a completed object such that irregularities in surface linearity are not introduced by flaps slotting into holes in the adjacent side edge when joining the sides to each other. In particular, this is important when the object is to be rendered with an image. Previous designs did not hide the joints so that they were still visible when viewing the outer surface of the completed container. In the instance of the casket and other such designs, one preferred embodiment uses flaps, which slot into corresponding holes on the inner surface of the container of a depth less than the thickness of the material of which the container is made.

In this preferred embodiment, and in many instances for other objects, adjoining sides comprise quadrilateral, and preferably dovetail-shaped extended flaps, which directly slot into corresponding holes of appropriate shape, wherein the slots are of a depth less than the thickness of the material and wherein the slots are formed by removing the inner surface and some or all of the rigid spacing material while maintaining the outer surface completely intact. This approach leaves the outer surface of the completed container perfectly flat so that an image may be rendered upon it. In addition, an internal surface of vinyl-like or paper material can be applied to seal the internal surface thereby holding the flaps more securely in place in the recessed holes on the inner surface and thereby further maintaining the integrity of the connected sides.

In alternative embodiments, and where it is appropriate, it is still in accordance with the current invention that one or more sides may make use of a method, which completely removes a slot of material including the outer surface. This is also appropriate when the edge join between two adjacent sides is hidden from view. In this case, a layer of vinyl-like or paper media can be applied to both surfaces to secure the joint.

In alternative embodiments, and where it is appropriate, it is still in accordance with the current invention that one or more sides may make use of a method, in which flaps from one side (A) slot into holes formed when an extended edge of the corresponding side (B) comprises reverse-shaped slots or holes matching the said flaps and wherein the extended edge folds back on itself and is fixed to the inner surface of side B, thereby bringing the slots or holes into the correct alignment and thereby enabling the flaps from side A to slot completely into the said holes.

In the preferred embodiment of the casket design FIG. 1, the vertical or nearly vertical sides (2,3,4,5,6,7) are integral with the base (8) of the casket. Each side comprises either extended quadrilateral flaps (9), preferably in the shape of dovetails to provide resistance against the two edges pulling apart when interlocked, and or appropriately shaped recesses or slots (10) such that the quadrilateral or dovetail flaps can be secured in place into the said slots or recesses.

Wherever a 90-degree angle is required, such as between the base (8) and some or all of the vertical or nearly vertical sides (2,3,4,5,6,7), a straight-line strip of material of width W is removed on the inside surface, where W=the thickness of the inner surface +thickness of the spacing material. In the preferred embodiment, none of the outer surface material is removed to ensure that the 9O-degree fold maintains the continuity of the outer surface from the base around the edge up the vertical walls.

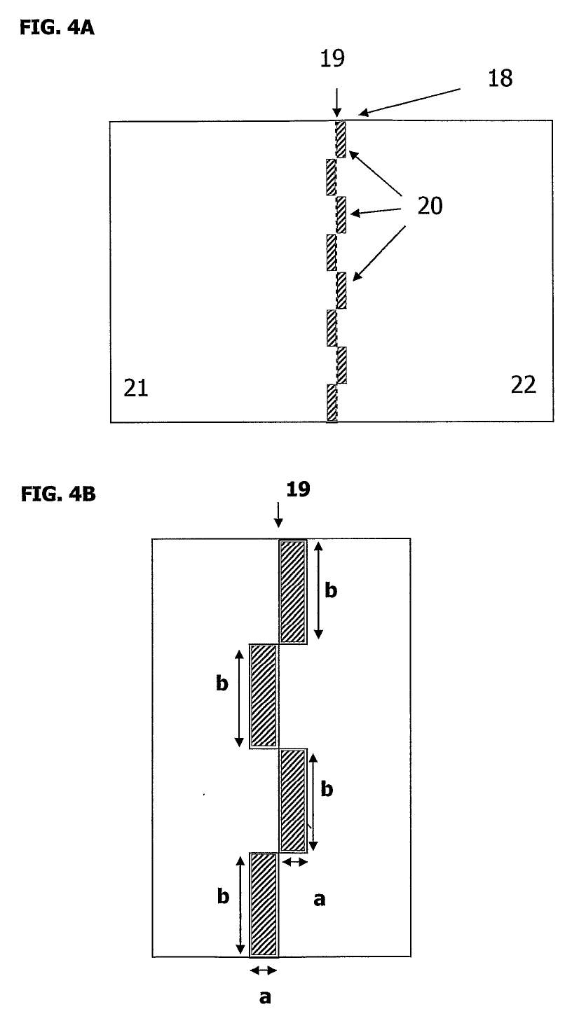

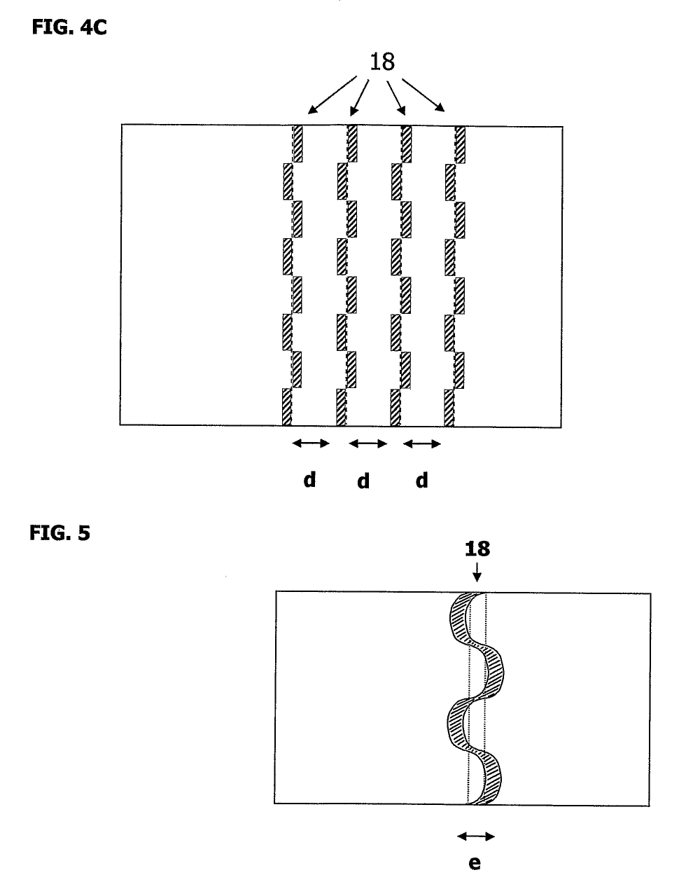

In the instance that an angle less than or greater than 90 degrees is required such as the end vertical side of the casket (7), which must lean out further at the top than at the bottom, then the joint described with reference to FIGS. 4A, 4B, and 4C can be used. Alternatively the serpentine joint described with reference to FIG. 5 may be used. These joints will be described in more detail in the following paragraphs.

With reference again to FIG. 1, the dovetail flaps (9) shown as extensions from four of the sides (2,5,6,7) are shown here by way of example only and may be situated along any of the sides, wherein the adjacent sides comprise the appropriate shaped slots to receive the said flaps. In alternative embodiments of this design, each side may comprise one or more flaps as well as slots, such that one or more flaps from side A are inserted into the corresponding one or more adjacent side slots in side B and one or more flaps from the adjacent side Bare received and inserted into the one or more corresponding slots in side A.

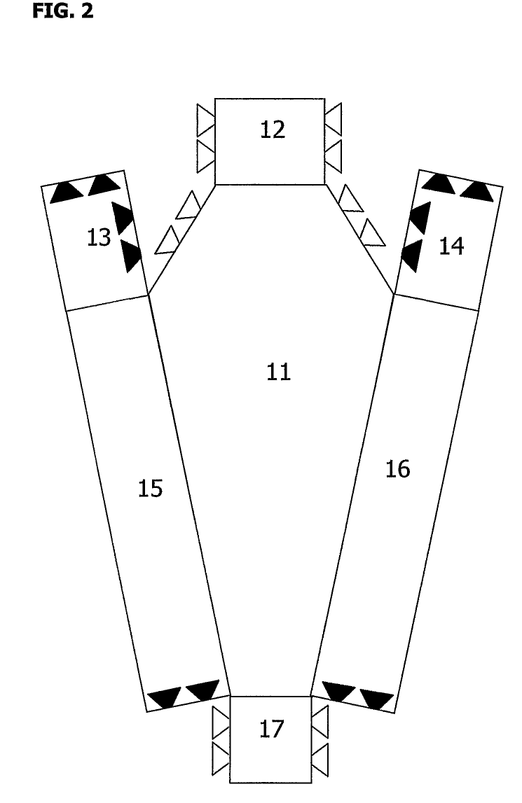

With reference to FIG. 2, therein illustrated is an alternative coffin design, which uses the interlocking joint shown in FIGS. 4A, 4B, and 4C or the joint shown in FIG. 5. The ideal coffin shape comprises the form shown with a wider interior dimension for the shoulders of the deceased. When creating this coffin from a flat bed printed design and from a singe sheet of material, there is a small amount of material available from which to construct the interlocking flaps. In this design, the joint described with reference to FIG. 4A is used between side 13 and side 15 and between side 14 and side 16.

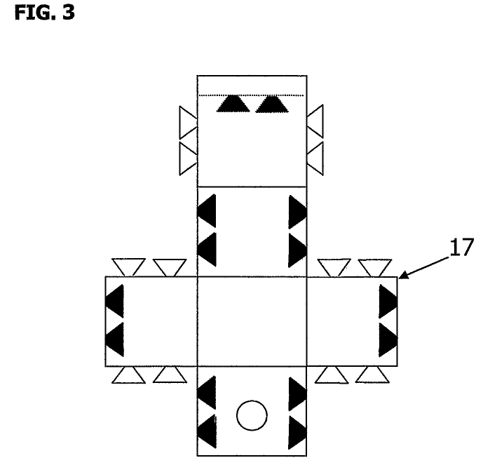

With reference to FIG. 3, therein illustrated is an example of a consumer product such as a nesting box (17) wherein the use of lightweight materials capable of being folded into desirable shapes, which may also comprise angular sides using the joints depicted in detail in FIGS. 4A, 48 and 4C and FIGS., makes possible the solution of replacing the nesting boxes each year rather than cleaning them out. Moreover, the image rendering method as described in detail in the objects of the invention can provide camouflage and protective covering to the nesting box in an efficient and effective way.

In one embodiment, the roof of the nesting box is flat with a projecting front edge and all the sides of the box are integrated together according to the system and method of the current invention with possible dovetail-like flaps and recesses in the adjacent sides as shown in FIG. 3.

With reference to FIG. 4A, therein is illustrated a novel joint (18) according to the current invention. This joint comprises making a continuous cut (19) on one face of the material and removing alternate and equal quadrilateral sections of material (20) as shown such that when the material is removed, it enables the two sides (21,22) to fold together and interlock at an angle determined by the width of the quadrilateral sections removed.

With reference to FIG. 4B, therein illustrated is a detail of the quadrilateral sections themselves. The continuous cut (19) is shown as well as the quadrilateral sections each of width (a) and length (b) wherein the width of the section (a) determines the angle of the fold at that point. The length (b) is chosen to optimise the compressional strength of the joint after the quadrilateral sections interlock.

With reference to FIG. 4C, therein illustrated is a schematic showing parallel cuts according to the method shown in FIG. 4A and FIG. 4B. As will be evident from the preceding objects of the invention, by selecting different values for the quadrilateral section width (a), and different spacing between the joints (18) the rate of curvature of the material is fully controllable.

With reference to FIG. 5, therein illustrated is a schematic showing an alternative embodiment of the novel joint in which two symmetrical serpentine continuous cuts are made in parallel to enable a serpentine segment of material to be removed from one side of the material thereby creating a sequence of interlocking curved projections wherein the width of the material removed (e) determines the resulting angle of the fold at that location. Curves can be made in the material using this serpentine cut shown in FIG. 5 in the same way as described with reference to FIG. 4C.

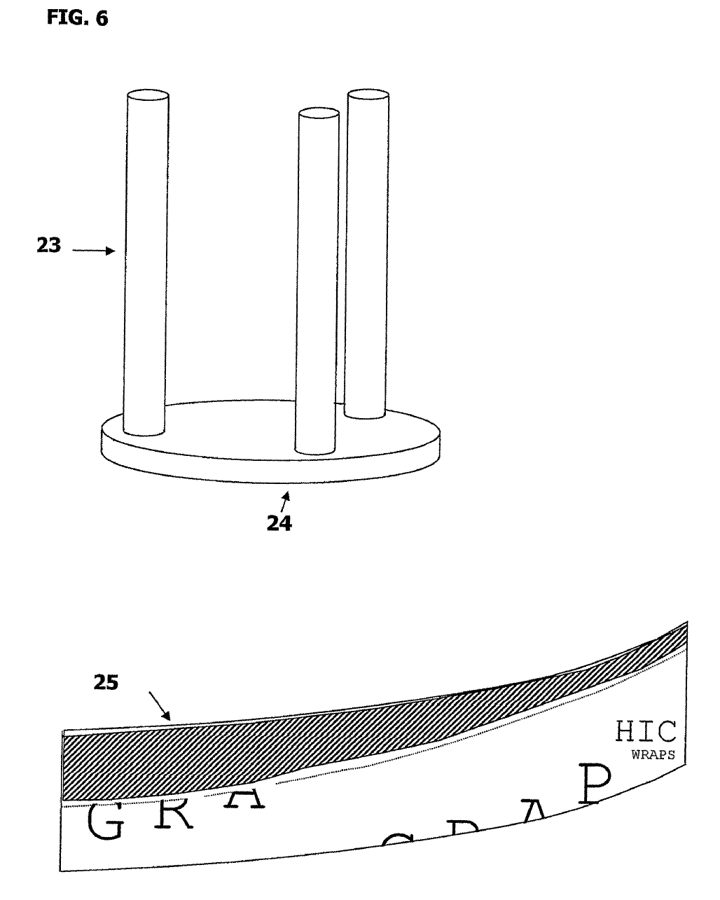

With reference to FIG. 6, therein illustrated is a schematic showing a design of a prism-like container making use of a spiral rendered image upon a vinyl-like or paper media wrapped around rods (23) set into a base (24). The image is printed in a format to provide a partially overlapping section of material, which is precisely aligned to provide continuity of the image as it wraps around the vertical rods so that an attractive and low cost container can be created. This method makes possible the creation of for example litterbins, which can be rendered with information and or colourful designs. The spiral design shown comprises a flexible sheet (25) of vinyl-like or paper media material with overlapping shaded areas (26), which can provide areas to glue the sheet to itself as it wraps around. When complete, the embodiment shown here reveals the name GRAPHIC WRAPS.

The previous paragraphs described a system and method for preparing a surface for rendering with an image and examples of how different consumer objects could be constructed using the novel joints of the current invention, and using vinyl-type and paper media, which overcome the problems of the prior art. The image rendering methods described in detail in the objects of the invention are highly suitable for rendering images upon the objects. In the particular instance of the nesting box depicted in FIG. 3 a whole variety of information can be added to a vinyl-based image such as nesting box code numbers and park warden service numbers etc., as well as camouflage images such as leaf designs in the appropriate colours

While only several embodiments of the present invention have been described in detail it will be obvious to those persons of ordinary skill in the art that many changes and modifications may be made thereunto without departing from the spirit of the invention.

1-19. (canceled)

20. A method for rendering an image upon the surface of a three-dimensional object having an inner surface and an outer surface, the method comprising:
selecting one of: a sheet of printed vinyl; a sheet of PVC; or a sheet of paper media; and
applying the selected sheet onto the outer surface and/or the inner surface of the three-dimensional object, for the purpose of: (a) associating an image and/or advertising text upon the outer and/or inner surface; (b) creating a continuous unbroken image on the outer surface of the three-dimensional object and/or on the inner surface of said three-dimensional object; (c) strengthening the structural integrity of the three-dimensional object; and (d) protecting the surface of the three-dimensional object.

21. A method according to claim 20 wherein the three-dimensional object is made of at least one of:
a plastic composite, wood, composite wood, veneered chipboard, veneered MDF, MDF (medium density fiberboard), carbon-fibre, cardboard, glass, paper, plastic, and material comprising two sheets separated by a spacing material, and honeycomb board.

22. A method according to claim 20 wherein the selected sheet has an image rendered thereon and reinforces the joints and/or vertices of the three-dimensional object, strengthens the structure of the three-dimensional object, and/or protects the outer surface of the three-dimensional object.

23. A method according to claim 21 wherein the selected sheet corresponds to a paper media provided from an adhesive-backed paper which is laminated on a front surface thereof with a polyester-based laminate and which is adapted to be applied to the inner or outer surface of the three-dimensional object.

24. A method according to claim 22 wherein the selected sheet corresponds to paper media provided from an adhesive-backed paper which is laminated on a front surface thereof with a polyester-based laminate and applied to the inner or outer surface of the three-dimensional object.

25. A method according to claim 22 wherein the selected sheet corresponds to paper media and the image is printed upon a first surface of the paper media and then subsequently an adhesive or adhesive sheet is applied to a second opposite surface of said paper media wherein the first surface of the paper is laminated with a polyester laminate to form a composite sheet and wherein said composite sheet is further applied to the inner or outer surface of the object.

26. A method according to claim 21 further comprising in that said two sheets of cardboard separated by a rigid spacing material, or honeycomb board, forming a base and a plurality of sides each comprising either quadrilateral or dovetail shaped flaps or appropriately shaped recesses or slots in order said flaps and recesses or slots are securely interlocked and each of said sides comprising a joint with said base and wherein said recesses or slots being made by removing some material from the surface of width W, wherein W is equal to the thickness of the inner surface added to the thickness of the spacing material, and leaving at least said outer surface intact for leveling the surface of the two sides in order to achieve an even outer surface ready to be totally covered by said sheet of vinyl or paper media rendering image.

27. A method according to claim 21, wherein the three-dimensional object is a coffin and the inner surface of the coffin is covered by a vinyl sheet or a PVC sheet in order to form an insulating barrier inside said coffin.

28. A method according to claim 22, wherein the three-dimensional object is a coffin and the inner surface of said coffin is covered by at least one of a vinyl sheet or a PVC sheet in order to form an insulating barrier inside the coffin.

29. A method according to claim 25, wherein the three-dimensional object is a coffin and the inner surface of the coffin is covered by one of a vinyl sheet or a PVC sheet in order to form an insulating barrier inside the coffin.

30. A method for rendering an image upon a surface of a three-dimensional object having an inner surface and an outer surface and having angles and/or curved sides and made of a material,, the method comprising:
covering one of the inner and outer surfaces of the three-dimensional object with one of a vinyl or a PVC or a paper media and then folded into a desired object comprising angled folds and interlocking joints;
or folded into a desired object comprising angled folds and interlocking joints and then rendered with an image by covering the total outer surface and/or total inner surface with a vinyl or PVC or paper media;
where the joints enable said material to be folded or curved into a predetermined shape and maintain structural integrity of the curved or folded area.

31. A method for rendering an image according to claim 30 further comprising manufacturing a three-dimensional object wherein covering comprises stretching or applying a printed sheet of vinyl or PVC or paper media over the material.

32. A method for rendering an image according to claim 30 which involves manufacturing a three-dimensional container wherein said two sheets of cardboard separated by a rigid spacing material, or honeycomb board, forming a base and a plurality of sides comprising either quadrilateral or dovetail shaped flaps or appropriately shaped recesses or slots in order that said flaps and recesses or slots are securely interlocked and each of said sides comprises a joint with said base wherein said recesses or slots are made by removing some material from the surface of width W, wherein W is equal to the thickness of the inner surface added to the thickness of the spacing material, and leaving said outer surface intact for leveling the surface of the placed sides in order to achieve an even outer surface ready to be rendered with said image.

33. A method according to claim 30 wherein making an interlocking joint comprises making one or a plurality of continuous cuts on one face of the surface of said material and making a sequence or alternating equal quadrilateral voids at right angles where material is removed from either side of said cut to leave a sequence of quadrilateral projections which interlock for forming a very strong angled fold along the line of a cut, while leaving the other surface of the material completely intact at the location of the joint, wherein the angle of the fold is variable and controllable and determined by the width of said quadrilateral void to said one or a plurality of continuous cuts and the length of said quadrilateral void is chosen to optimise the compressional strength of said joint after said quadrilateral sections interlock.

34. A method according to claim 30 wherein making one or more interlocking joints further comprises repeating making one or a plurality of continuous parallel cuts a plurality of times where each of said continuous cuts is separated by a spacing (d) between said joints and repeating said step of making a sequence of alternating equal quadrilateral voids along each of said cuts, wherein the rate of the curvature is fully controlled by varying said spacing (d).

35. A method according to claim 34 wherein making one or a plurality of continuous cuts is replaced by making one or a plurality of pairs of parallel symmetrical serpentine continuous cuts and making a sequence of alternating equal quadrilateral voids at right angles is replaced by removing serpentine segments of said material wherein the width (e) of the removed material determines the resulting angle of the fold.

36. A method according to claim 34 further comprising folding and or curving said material with its prepared surface into its final 3-dimensional form along said cuts and, fixing said desired object in its final form to create an even surface, rendering said image by stretching or applying a printed sheet of vinyl or PVC or paper media onto the outer surface and/or the inner surface of said desired final object to cover said outer surface totally and/or covering said inner surface totally with the same or with another image or with a clear or a coloured sheet.

37. A method according to claim 35 further comprising:
rendering said material with an image by stretching or applying a printed sheet of vinyl or PVC or paper media onto one or both surfaces of said material to cover said one or both surfaces totally with the same or with another image or with a clear or a coloured sheet,
folding and or curving said material with its prepared surface into its final 3-dimensional form along said cuts and, fixing said desired object in its final form to create an even surface.

38. A product comprising a rendered image according to the method of claim 21 consisting of one of the group of a coffin, and ashes casket, a pet ashes casket, a chair, a chair seat, a chair back, a door, a wardrobe, a drawer front, a drawer bottom, a partition wall, an exhibition stand, a toy box, a storage box, a bedroom headboard, a flower pot, a waste bin, a dog excrement bin, an exhibition stand, an interlocking storage box, a dog kennel, a nesting box, a computer device, a mobile phone, a drinking container, a power tool, a window, a partition wall, a pet home, a horse box, a caravan, a motor home, a freight container, a surf board, a fence panel, a room divider, a window blind, a storage box comprising part or complete images, a dressing table, and a bath panel.

39. A product comprising a rendered image according to the method of claim 22 consisting of one of the group of a coffin, an ashes casket, a pet ashes casket, a chair, a chair seat, a chair back, a door, a wardrobe, a drawer front, a drawer bottom a partition wall, an exhibition stand, a toy box, a storage box, a bedroom headboard, a flower pot, a waste bin, a dog excrement bin, an exhibition stand, an interlocking storage box, a dog kennel, a nesting box, a computer device, a mobile phone, a drinking container, a power tool, a window, a partition wall, a pet home, a horse box, a caravan, a motor home, a freight container, a surf board, a fence panel, a room divider, a window blind, a storage box comprising part or complete images, a dressing table, and a bath panel.

40. A storage box formed with a rendered image as disclosed in claim 39 comprising part or complete images which may stack together wherein part images from separate boxes combine to form a complete image when stacked together correctly.
